(19) United States
(12) Patent Application Publication
(10) Pub. No.: US 2018/0033535 A1
(43) Pub. Date: Feb. 1, 2018

(54) COIL COMPONENT AND METHOD OF MANUFACTURING THE SAME

(71) Applicant: SAMSUNG ELECTRO-MECHANICS CO., LTD., Suwon-si (KR)

(72) Inventors: Seok Il HONG, Suwon-si (KR); Ju Hwan YANG, Suwon-si (KR); Young Seuck YOO, Suwon-si (KR); Won Chul SIM, Suwon-si (KR)

(21) Appl. No.: 15/487,979

(22) Filed: Apr. 14, 2017

(30) Foreign Application Priority Data
Jul. 28, 2016 (KR) 10-2016-0096206

(51) Int. Cl. H01F 27/255; H01F 41/04; H01F 27/28; H01F 41/02; H01F 27/245

(52) U.S. Cl. CPC H01F 27/255; H01F 41/0233; H01F 27/245; H01F 27/2804; H01F 41/041

(57) ABSTRACT

A method of manufacturing a coil component includes preparing a coil unit including a coil surrounded by an insulating film. The coil unit further has a through hole in a center thereof and has a first surface and a second surface opposing each other. A first magnetic sheet and a second magnetic sheet containing magnetic particles are prepared, and the first magnetic sheet is pressed onto the first surface of the coil unit to cause the first magnetic sheet to fill the through hole therewith. The second magnetic sheet is pressed onto the second surface of the coil unit. The second magnetic sheet may be pressed onto a portion of the first magnetic sheet that extends through the through hole and outwardly from the second surface of the coil unit.

### CROSS-REFERENCE TO RELATED APPLICATION

This application claims the benefit of priority to Korean Patent Application No. 10-2016-0096206, filed on Jul. 28, 2016 with the Korean Intellectual Property Office, the entirety of which is incorporated herein by reference.

### BACKGROUND

### 1. Field

The present disclosure relates to a coil component and a method of manufacturing the same.

### 2. Description of Related Art

An inductor, such as a coil component, may be combined with a capacitor through electromagnetism to provide a resonance circuit, a filter circuit, or the like, for amplifying a signal within a specific frequency band. The inductor can also be used as a typical passive component and coil component for removing noise while forming an electronic circuit together with a resistor and a capacitor.

In recent years, the miniaturization and thinning of information technology (IT) devices, such as communications devices and display devices, have accelerated. Research into the miniaturization and thinning of various devices such as inductors, capacitors, transistors, and the like, applied to such IT devices has been continuously carried out.

Despite such miniaturization, the level of performance required of a coil component is the same or slightly increased. In an inductor, such as a coil component, characteristics such as capacitance, direct current superposition characteristics, loss efficiency, and the like are considered important.

To improve characteristics of a coil component, a coil having a plurality of layers is provided. As a coil having a plurality of layers is provided, an aspect ratio of a core located in the center of a coil unit is increased.

Generally, a core is formed in such a manner that a through hole is formed in the center of a coil unit and the through hole is filled with a magnetic material. In this case, when an aspect ratio of a core is increased, a problem in which filling of the through hole is limited may occur.

Due to a high aspect ratio, when a region in which magnetic powder particles are not uniformly disposed is generated in a through hole, a reduction in characteristics of a coil component may occur.

Therefore, in a coil component, a method for improving filling properties of a magnetic particle in a through hole is required.

### SUMMARY

An aspect of the present disclosure provides a coil component in which a magnetic particle is uniformly dispersed in a core and a method of manufacturing the same.

According to an aspect of the present disclosure, a method of manufacturing a coil component includes preparing a coil unit having a through hole in a center thereof. The coil unit includes a coil surrounded by an insulating film, and has a first surface and a second surface opposing each other. A first magnetic sheet and a second magnetic sheet each containing magnetic particles are prepared, and the first magnetic sheet is pressed onto a first surface of the coil unit to cause the first magnetic sheet to fill the through hole therewith. The second magnetic sheet is pressed onto a second surface of the coil unit.

According to another aspect of the present disclosure, a coil component includes a coil unit, a core, and first and second cover portions. The coil unit has a through hole in a center thereof, includes a coil surrounded by an insulating film, and has a first surface and a second surface opposing each other. The core is disposed in the through hole, the first cover portion is disposed on the first surface of the coil unit, and the second cover portion is disposed on the second surface of the coil unit. The first cover portion and the core are integrally formed of a first magnetic sheet, the second cover portion is formed of a second magnetic sheet, and a surface in which the core formed of the first magnetic sheet is in contact with the second cover portion formed of the second magnetic sheet is disposed outside of the coil unit.

According to another aspect of the present disclosure, method of manufacturing a coil component including forming a core to extend through a through hole of a coil unit including at least one coil encapsulated in an insulating film. In particular, the core is formed to extend outwardly through a surface of the coil unit. Following the forming of the core to extend outwardly through the surface of the coil unit, a magnetic substance sheet is pressed on the surface of the coil unit through which the core extends and on the core that extends outwardly through the surface of the coil unit.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a schematic cross-sectional view of a coil component according to an exemplary embodiment;

FIG. 2 is an image of a cross section of a coil component according to an exemplary embodiment, captured by an electron microscope;

FIG. 3 is a schematic cross-sectional view of a coil component according to another exemplary embodiment;

FIG. 4 is a flow chart of a method of manufacturing a coil component according to a different exemplary embodiment; and

FIGS. 5 to 9 are schematic cross-sectional views illustrating steps in a method of manufacturing a coil component according to a different exemplary embodiment.

### DETAILED DESCRIPTION

Hereinafter, embodiments of the present disclosure will be described as follows with reference to the attached drawings.

The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Throughout the specification, it will be understood that when an element, such as a layer, region, or wafer (substrate) is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no other elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers, and/or sections, these members, components, regions, layers, and/or sections should not be limited by these terms. These terms are only used to distinguish one member, component, region, layer, or section from another member, component, region, layer, or section. Thus, a first member, component, region, layer, or section discussed below could be termed a second member, component, region, layer, or section without departing from the teachings of the exemplary embodiments.

Spatially relative terms, such as “above,” “upper,” “below,” “lower,” and the like, may be used herein for ease of description to describe one element's positional relationship relative to other element(s) as shown in an orientation shown in the figures. It will be understood that the spatially relative terms are intended to encompass different orientations of the device in use or operation in addition to the orientation depicted in the figures. For example, if the device in the figures is turned over, elements described as “above” or “upper” relative to other elements would then be oriented “below” or “lower” relative to the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein describes particular embodiments only, and the present disclosure is not limited thereby. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, members, elements, and/or groups, but do not preclude the presence or addition of one or more other features, integers, steps, operations, members, elements, and/or groups.

Hereinafter, embodiments will be described with reference to schematic views illustrating embodiments of the present disclosure. In the drawings, components having ideal shapes are shown. However, variations from these ideal shapes, for example due to variability in manufacturing techniques and/or tolerances, also fall within the scope of the disclosure. Thus, embodiments of the present disclosure should not be construed as being limited to the particular shapes of regions shown herein, but should more generally be understood to include changes in shape resulting from manufacturing methods and processes. The following embodiments may also be constituted by one or a combination thereof.

The present disclosure describes a variety of configurations, and only illustrative configurations are shown herein. However, the disclosure is not limited to the particular illustrative configurations presented herein, but extends to other similar/analogous configurations as well.

Coil Component

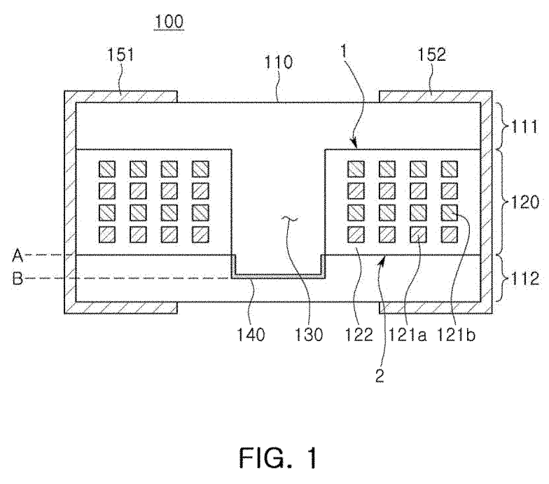

FIG. 1 is a schematic cross-sectional view of a coil component 100 according to an exemplary embodiment.

With reference to FIG. 1, the coil component 100 according to an exemplary embodiment may include a body 110, as well as external electrodes 151 and 152 disposed on opposite end surfaces of the body in a longitudinal direction.

The body 110 may include a coil unit 120, as well as a first cover portion 111 and a second cover portion 112 disposed on a first surface 1 and a second surface 2 of the coil unit 120, respectively.

Since the first cover portion 111 and the second cover portion 112 are formed by pressing a magnetic sheet, magnetic flux may flow in the first cover portion 111 and the second cover portion 112.

The body 110 may form an exterior of the coil component 100, and may be formed of any material having magnetic properties without limitation.

The material having magnetic properties may be a ferrite powder or a magnetic metal powder.

The ferrite powder may be formed of Mn—Zn-based ferrite, Ni—Zn-based ferrite, Ni—Zn—Cu-based ferrite, Mn—Mg-based ferrite, Ba-based ferrite, Li-based ferrite, or the like.

The magnetic metal powder may include at least one selected from the group consisting of iron (Fe), silicon (Si), chromium (Cr), aluminum (Al), and nickel (Ni), and may be, for example, an Fe—Si—B—Cr-based amorphous metal, but an exemplary embodiment is not limited thereto.

A particle diameter of the ferrite powder or the magnetic metal powder may be in the range of 0.1 μm to 30 μm, and the ferrite powder or the magnetic metal powder may be included in the form in which the ferrite powder or the magnetic metal powder is dispersed in thermosetting resin such as epoxy resin, or the like.

The coil unit 120 may include a coil having one or more layers.

For example, the coil unit 120 may include a first coil 121a and a second coil 121b.

When the coil unit 120 includes the first coil 121a and the second coil 121b, the coil component 100 may be used as a common mode filter.

When the first coil 121a and the second coil 121b each have a plurality of layers, coil windings located in different layers may be electrically connected to each other by a conductive via (not shown) as required.

In addition, one end of the first coil 121a and one end of the second coil 121b may be exposed to an exterior of the body 110 to be electrically connected to the external electrodes 151 and 152, respectively.

The first coil 121a and the second coil 121b may be coated with an insulating film 122.

The insulating film 122 may be formed using a method such as screen printing, a process of exposure and development of a photoresist, a spray coating process, or the like.

Since the first coil 121a and the second coil 121b are coated with the insulating film 122, the first coil 121a and the second coil 121b may be electrically insulated from a magnetic material forming the body 110.

The first coil 121a and the second coil 121b may be formed of silver (Ag) or copper (Cu). The first coil 121a and the second coil 121b may be formed by spirally printing conductive paste on a magnetic sheet, or by plating.

A core 130 is disposed in a center of the coil unit 120.

The core 130 may be formed by filling a through hole, passing from the first surface 1 of the coil unit 120 to the second surface 2 thereof with a first magnetic sheet.

In this case, the first magnetic sheet forms a first cover portion 111 and the core 130, and a second magnetic sheet forms a second cover portion 112.

In a case of a coil component according to an exemplary embodiment, a surface 140 in which the first magnetic sheet is in contact with the second magnetic sheet may be disposed outside of (or spaced away from, or spaced apart from, or unaligned with the second surface 2 of) the coil unit 120.

With reference to FIG. 1, when a location of a surface in which the coil unit 120 is in contact with the second cover portion 112 is A, and a location of the surface 140 in which the first magnetic sheet is in contact with the second magnetic sheet is B (where the surfaces A and B are parallel), B may be disposed further outwardly than A, based on a center of the body 110.

When the first magnetic sheet and the second magnetic sheet are pressed on the first surface 1 and the second surface 2 of the coil unit 120, respectively, to form the core 130, due to a difference in fluidity between a magnetic particle contained in a magnetic sheet and a resin, a problem may occur in which an area in which magnetic powder particles are not uniformly disposed is formed inside of the core 130.

However, in the coil component 100 according to an exemplary embodiment, since the surface 140 in which the first magnetic sheet is in contact with the second magnetic sheet is disposed outside of the coil unit 120, a magnetic particle may be uniformly disposed inside of the core 130.

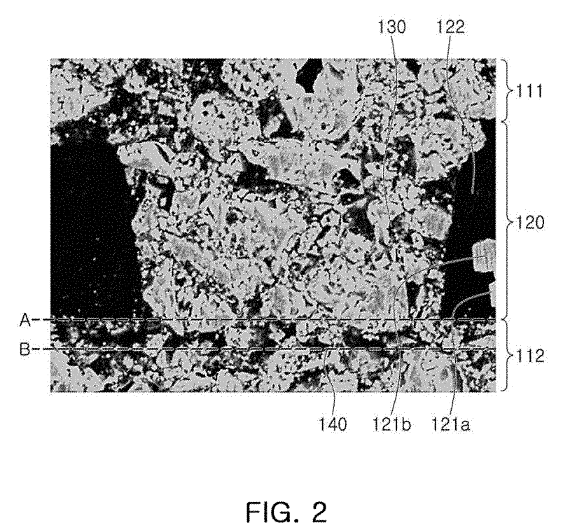

FIG. 2 is an image of across section of the coil component 100 according to an exemplary embodiment, captured by an electron microscope.

With reference to FIG. 2, it is confirmed that the surface 140 in which a first magnetic sheet is in contact with a second magnetic sheet is disposed outside of the coil unit 120 (or offset from a lower surface of the coil unit 120).

In detail, it is confirmed that magnetic particles contained in the core 130 are uniformly distributed throughout the core 130.

Thus, in the coil component 100 according to an exemplary embodiment, as the surface 140 in which the first magnetic sheet is in contact with the second magnetic sheet is disposed outside of the coil unit 120, an area in which a magnetic particle is not uniformly disposed is prevented from being formed inside of the core 130, thereby preventing a performance of the coil component 100 from being degraded.

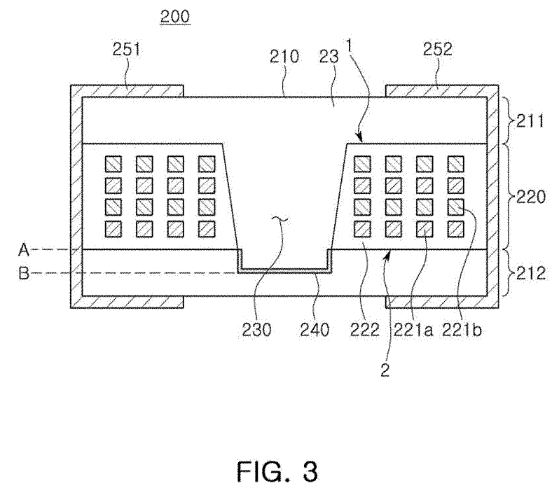

FIG. 3 is a schematic cross-sectional view of a coil component 200 according to another exemplary embodiment.

A description of a configuration the same as or similar to the configuration described above will be omitted.

With reference to FIG. 3, a width of a core 230 included in the coil component 200 according to the other exemplary embodiment is narrowed (or tapered) from a first surface 1 of a coil unit 220 to a second surface 2 thereof.

When a through hole for formation of the core 230 is formed in the coil unit 220, the through hole may be formed not to have sides that are perpendicular to the first surface 1 or the second surface 2. Instead, the through hole may be formed to allow a width thereof to be gradually narrowed from the first surface 1 to the second surface 2.

When an aspect ratio of a core having sides perpendicular to the first surface 1 or the second surface 2 is increased above a predetermined value, it becomes further difficult to form the core by filling the through hole.

However, in a manner the same as the coil component 200 according to another exemplary embodiment, when a width of the core 230 is formed to be gradually narrowed from the first surface 1 to the second surface 2, the through hole may easily be filled with a magnetic material even when the aspect ratio of the core is above the predetermined value.

Method of Manufacturing a Coil Component

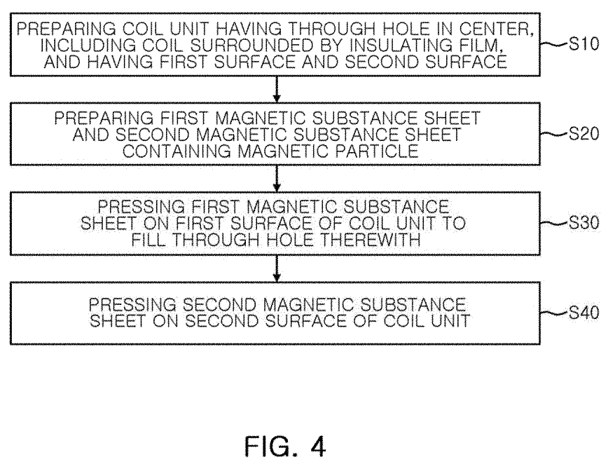

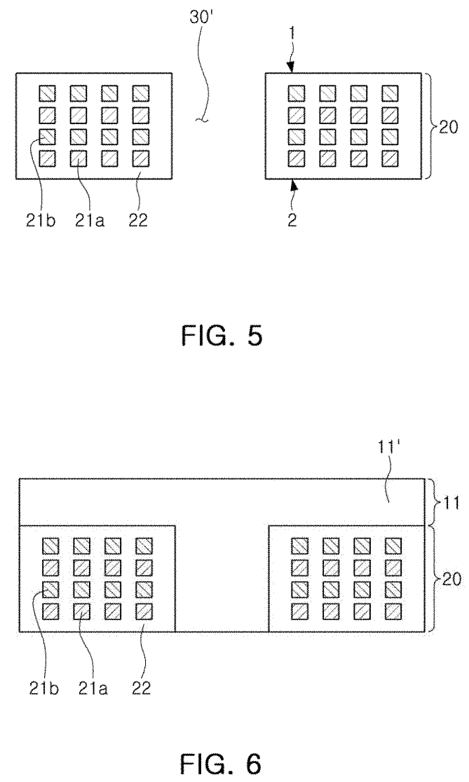

FIG. 4 is a flow chart illustrating a method of manufacturing a coil component according to a different exemplary embodiment, and FIGS. 5 to 9 are schematic cross-sectional views illustrating operations or steps in the method of manufacturing a coil component according to the different exemplary embodiment.

Hereinafter, with reference to FIG. 4 and FIGS. 5 to 9, a method of manufacturing a coil component according to the different exemplary embodiment will be described.

First, as illustrated in FIG. 5, an operation S10 is performed to prepare a coil unit 20 having a through hole 30′ in a center thereof, including coils 21a and 21b surrounded by an insulating film 22, and having a first surface 1 and a second surface 2.

The through hole 30′ may be formed using mechanical drilling or laser drilling, but an exemplary embodiment is not limited thereto. For example, the laser drill may be a CO₂ laser or a YAG laser.

In some examples, the through hole 30′ may include a first through hole whose width is gradually narrowed from the first surface 1 of the coil unit 20 to the second surface 2, as illustrated in FIG. 3, or a second through hole whose width is gradually narrowed from the second surface 2 of the coil unit 20 to the first surface 1.

The coils 21a and 21b may be formed using conductive metal such as silver (Ag), copper (Cu), or the like. For a method of forming the coils 21a and 21b, after the coils 21a and 21b are formed by printing conductive paste on a magnetic sheet or plating, the coils 21a and 21b may be encapsulated by the insulating film 22.

The coils 21a and 21b may include a plurality of layers or a plurality of coils, as required.

For example, when a coil component is a common mode filter, the coils 21a and 21b may include a first coil 21a and a second coil 21b.

The insulating film 22 may be formed using a method such as a screen printing method, a process of exposure and development of photoresist, a spray coating process, or the like.

Concurrently with or before/after the operation S10 of preparing the coil unit 20, an operation S20 of preparing a first magnetic sheet 11′ and a second magnetic sheet 12′ is performed.

The first magnetic sheet 11′ and the second magnetic sheet 12′ may be formed by dispersing magnetic particles in epoxy resin, or the like, but an exemplary embodiment is not limited thereto.

The magnetic particles may be particles of a ferrite powder or a magnetic metal powder.

The ferrite powder may be formed of Mn—Zn-based ferrite, Ni—Zn-based ferrite, Ni—Zn—Cu-based ferrite, Mn—Mg-based ferrite, Ba-based ferrite, Li-based ferrite, or the like.

The magnetic metal powder may include at least one selected from the group consisting of Fe, Si, Cr, Al, and Ni, and may be, for example, an Fe—Si—B—Cr-based amorphous metal, but an exemplary embodiment is not limited thereto.

A particle diameter of the ferrite powder or the magnetic metal powder may be 0.1 μm to 30 μm.

The first magnetic sheet 11′ and the second magnetic sheet 12′ may be a sheet having good fluidity and low viscosity.

Next, as illustrated in FIG. 6, an operation S30 of entirely filling the through hole 30′ by pressing the first magnetic sheet 11′ on the first surface 1 of the coil unit 20 is performed.

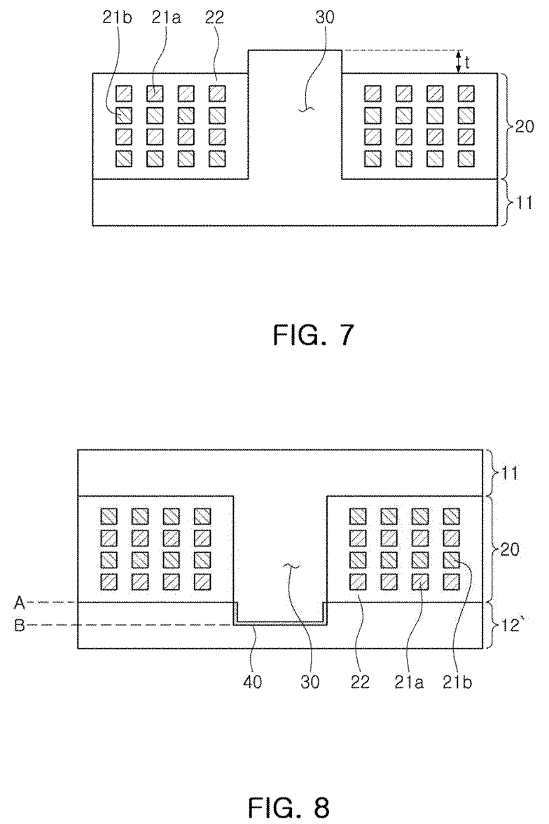

In this case, the first magnetic sheet 11′ fills the through hole 30′ to form a core 30. As a result, the first magnetic sheet 11′ will be provided as the core 30 and as a first cover portion 11, as shown in FIG. 7.

Then, as illustrated in FIG. 8, an operation S40 of pressing the second magnetic sheet 12′ on the second surface of the coil unit 20 is performed. As a result, the second magnetic sheet 12′ is provided as a second cover portion 12.

However, after the first magnetic sheet 11′ is pressed on the first surface 1 of the coil unit 20, an operation of etching the second surface 2 of the coil unit 20 before the second magnetic sheet 12′ is pressed on the second surface 2 of the coil unit 20 may be further included.

In detail, after the first magnetic sheet 11′ is pressed on the first surface 1 of the coil unit 20, the coil unit 20 to which the first cover portion 11 is attached is turned upside down, and then, the second surface 2 of the coil unit 20 is etched.

With reference to FIG. 7, the second surface of the coil unit 20 is etched by a predetermined distance t to allow the first magnetic sheet 11′ filling the through hole 30′ to protrude from an etched surface of the coil unit 20.

Through such an etching process with respect to the second surface the coil unit 20, roughness of the second surface of the coil unit 20 is increased to additionally form a coupler, and thus, a bonding force of the coil unit 20 and the second magnetic sheet 12′ may be increased.

When the first magnetic sheet 11′ fills the through hole 30′, due to a difference in fluidity between magnetic particles and resin, a region in which magnetic powder particles are not uniformly disposed may be formed in an end of the first magnetic sheet 11′ filling the through hole 30′. The region in which magnetic powder particles are not uniformly disposed is removed in an etching process with respect to the second surface of the coil unit 20, and thus, a magnetic particle may be uniformly disposed in the core 30 that remains in the coil unit 20, as well as in cover portions 11 and 12.

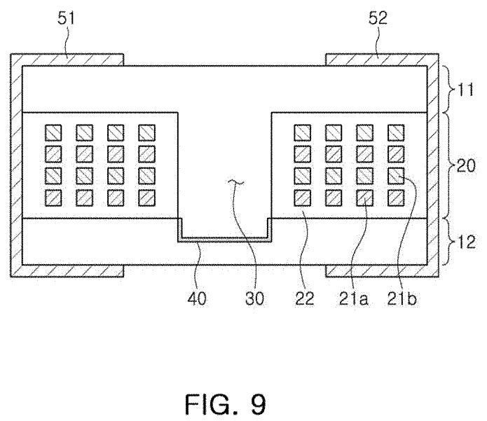

Finally, an operation of forming external electrodes 51 and 52 is performed, as shown in FIG. 9.

The external electrodes 51 and 52 may be formed in a method such as dipping, sputtering, or the like, but an exemplary embodiment is not limited thereto.

As compared with the case of using a magnetic paste according to the related art, the method of manufacturing a coil component according to a different exemplary embodiment has the advantages that material costs are low and a process is simple.

However, in the case in which a magnetic sheet is used, when the through hole 30′ is filled, a problem in which filling properties are reduced may occur. In detail, when an aspect ratio of the through hole 30′ is increased, filling properties of the through hole 30′ using a magnetic sheet may be further reduced.

However, in the method of manufacturing a coil component according to a different exemplary embodiment, since the first magnetic sheet 11′ is pressed on the first surface of the coil unit 20 to fill the through hole 30′, filling properties of the through hole 30′ may be improved. Furthermore, since a magnetic particle is uniformly disposed in the core 30, a performance of the coil component manufactured in the method of manufacturing a coil component according to a different exemplary embodiment may be improved.

As set forth above, according to an exemplary embodiment, in a method of manufacturing a coil component, as a magnetic sheet containing a magnetic particle is pressed on a through hole having a high aspect ratio to form a core, a fill factor of a magnetic sheet in a through hole may be improved. In addition, as a magnetic particle is uniformly dispersed in a core, a performance of a coil component may be improved.

According to a different exemplary embodiment, in a coil component, as a contact surface of magnetic sheets disposed above and below a coil unit is disposed outside of the coil unit, a magnetic body may be continuously disposed inside of a core, thereby preventing a performance of a coil component from being degraded.

While exemplary embodiments have been shown and described above, it will be apparent to those skilled in the art that modifications and variations could be made without departing from the scope of the present invention as defined by the appended claims.

What is claimed is:

1. A method of manufacturing a coil component, comprising:
preparing a coil unit having a through hole in a center thereof, including a coil surrounded by an insulating film, and having a first surface and a second surface opposing each other;
preparing a first magnetic sheet and a second magnetic sheet each containing magnetic particles;
pressing the first magnetic sheet onto the first surface of the coil unit to cause the first magnetic sheet to fill the through hole therewith; and
pressing the second magnetic sheet onto the second surface of the coil unit.

2. The method of manufacturing a coil component of claim 1, further comprising:
etching the second surface of the coil unit, after pressing the first magnetic sheet onto the first surface of the coil unit.

3. The method of manufacturing a coil component of claim 2, wherein the etching the second surface of the coil unit is performed to allow the first magnetic sheet filling the through hole to protrude from the second surface of the coil unit subject to the etching.

4. The method of manufacturing a coil component of claim 2, wherein the etching comprises etching a surface of the first magnetic sheet that extends outwardly through the second surface of the coil unit.

5. The method of manufacturing a coil component of claim 1, wherein a surface in which the first magnetic sheet is in contact with the second magnetic sheet is disposed outside of the coil unit.

6. The method of manufacturing a coil component of claim 1, wherein a surface in which the first magnetic sheet is in contact with the second magnetic sheet is spaced apart from the second surface of the coil unit.

7. The method of manufacturing a coil component of claim 1, wherein a width of the through hole in the first surface of the coil unit is wider than a width of the through hole in the second surface of the coil unit.

8. The method of manufacturing a coil component of claim 1, wherein the coil includes a first coil and a second coil.

9. A coil component, comprising:
a coil unit having a through hole in a center thereof, including a coil surrounded by an insulating film, and having a first surface and a second surface opposing each other;
a core disposed in the through hole; and
a first cover portion disposed on the first surface of the coil unit and a second cover portion disposed on the second surface of the coil unit,
wherein the first cover portion and the core are integrally formed of a first magnetic sheet,
the second cover portion is formed of a second magnetic sheet, and
a surface in which the core formed of the first magnetic sheet is in contact with the second cover portion formed of the second magnetic sheet is disposed outside of the coil unit.

10. The coil component of claim 9, wherein the core formed of the first magnetic sheet protrudes outside of the coil unit through the second surface of the coil unit.

11. The coil component of claim 9, wherein a width of the core in the first surface of the coil unit is wider than a width of the core in the second surface of the coil unit.

12. The coil component of claim 9, wherein the coil includes a first coil and a second coil.

13. A method of manufacturing a coil component, comprising:
forming a core to extend through a through hole of a coil unit including at least one coil encapsulated in an insulating film, wherein the core is formed to extend outwardly through a surface of the coil unit; and
following the forming of the core to extend outwardly through the surface of the coil unit, pressing a magnetic substance sheet on the surface of the coil unit through which the core extends and on the core that extends outwardly through the surface of the coil unit.

14. The method claim 13, wherein the forming the core to extend outwardly through the surface of the coil unit comprises etching the surface of the coil unit through which the core extends to cause the core to protrude from the surface of the coil unit subject to the etching.

15. The method claim 14, wherein the etching the surface of the coil unit comprises etching a portion of the core that extends outwardly through the surface of the coil unit.

16. The method of claim 15, wherein following the etching of the core, the core includes another portion of the core that extends outwardly through the surface of the coil unit.

17. The method of claim 13, further comprising:
following the forming of the core to extend outwardly through the surface of the coil unit and prior to pressing the magnetic substance sheet on the surface of the coil unit, etching a portion of the core that extends outwardly through the surface of the coil unit,
wherein the magnetic substance sheet is pressed on the surface of the coil unit through which the core extends to contact the core subjected to etching.

18. The method claim 13, further comprising:
prior to forming the core, forming in the coil unit the through hole having a substantially cylindrical shape extending through the coil unit.

19. The method claim 13, further comprising:
prior to forming the core, forming in the coil unit the through hole extending between first and second opposing surfaces of the coil unit,
wherein the through hole is formed to have a cross sectional area in the first surface of the coil unit that is smaller than a cross sectional area of the through hole in the second surface of the coil unit.

20. The method claim 19, wherein the core is formed to extend outwardly through the first surface of the coil unit in which the through hole has the smaller cross sectional area.

21. The method claim 13, further comprising:
forming, directly on an external surface of the magnetic substance sheet that is pressed on the surface of the coil unit through which the core extends to contact the core, external electrodes electrically connected to the coil unit.
